(19) United States
(12) Patent Application Publication
(10) Pub. No.: US 2007/0210137 A1
(43) Pub. Date: Sep. 13, 2007

(54) Base dispensing tool for tube supports and method of utilizing same

(76) Inventors: Reynaldo P. Lugo JR., Phoenix, AZ (US); John Mapalo, Phoenix, AZ (US)

Correspondence Address: REYNALDO P. LUGO, JR., 1821 E. ROSE LANE, PHOENIX, AZ, 85016, US

(21) Appl. No.: 11/371,682

(22) Filed: Mar. 8, 2006

(51) Int. Cl. A47J 36/02

(52) U.S. Cl. 228/101

(57) ABSTRACT

A tool (62) retains a plurality of bases (36) for tube supports (30). Each base (36) includes a body (44) having a finger (52) extending into an interior (46) of the body (44) and a foot (54) extending outwardly from the body (44). The tool (62) includes a rod (64) with a lengthwise groove (90) that curves about distal end (68) of the rod (64). Bases (36) slide on the rod (64) with the finger (52) of each base (36) seated in the groove (90). Curvature of the groove (90) causes the foot (54) of the endmost base (36′) to face in a different direction from the feet (54) of the remaining bases (36) so that it can be accessed for welding to a surface (28). Following welding, the endmost base (36′) is released from the rod (64) and the remaining bases (36) slide on rod (64) toward the distal end (68).

### TECHNICAL FIELD OF THE INVENTION

The present invention relates to the field of sign manufacturing. More specifically, the present invention relates to facilitating the installation of tube supports for luminescent gas filled tubing of dimensional signage.

### BACKGROUND OF THE INVENTION

Luminescent gas filled tubing is widely used to make lighted advertising signage, decorations, and the like. The most commonly utilized gas is neon. However, other luminescent gases, such as argon, helium, xenon, krypton, mercury vapor, and so forth, are used to produce different colors of light. The term “neon”, as in “neon sign”, is used in the industry and herein as the generic term for these types of lights.

Neon signs customarily include frames or panels on which the configured gas filled tubing is supported by standoffs, typically referred to as tube supports. These tube supports are designed to hold the gas filled tubing in a fixed position and to act as shock absorbers, which function to allow the gas filled tubing to flex a little, rather than to fracture when the neon sign is subjected to a distorting or a vibrational force.

An ideal tube support is one that can be mass produced inexpensively, requires minimal assembly effort, is easy to use in practical application, and produces no corona discharge in the presence of a high voltage electric field. Reducing the material cost of tube supports is important because a neon sign manufacturer may use many such tube supports when fabricating neon signs.

A pan channel letter, also known as a dimensional letter, is constructed with side walls, a back wall, and a face making the letter a solid integral unit with the side walls and back wall having a pan-shaped cross section. Gas filled tubing may be installed within the pan channel letter, thus illuminating the face of the letter. Alternatively, a pan channel letter can include exposed gas filled tubing or can be reverse lit.

When a pan channel letter is to include internal gas filled tubing, tube supports are typically mounted against the back and/or side walls of the pan channel letter. In small to medium fabrication shops, this task may be manually accomplished. For example, a worker may manually insert the metal base of a tube support into the pan channel letter, and then spot-weld, punch, or otherwise attach the tube support base to the pan channel letter. This procedure is repeated individually in succession for each tube support.

Although material cost is one factor that should be considered when fabricating neon signs, another perhaps more overriding factor is direct labor cost. The individual attachment of tube supports in a pan channel letter can be both tedious and time consuming, thus costly to produce in terms of direct labor cost. Moreover, manual manipulation of tube support bases can lead to inaccurate placement and/or inadequate attachment of the tube support bases.

Consequently, what is needed is a method and tooling for facilitating installation of metal bases of tube supports onto a surface, such as inside a pan channel letter.

### SUMMARY OF THE INVENTION

Accordingly, it is an advantage of the present invention that a base dispensing tool is provided for facilitating installation of tube supports onto a surface.

It is another advantage of the present invention that a base dispensing tool and installation methodology is provided that speed up sign fabrication process.

Yet another advantage of the present invention is that a base dispensing tool and installation methodology are provided that reduce production costs while increasing production quality of neon signage.

The above and other advantages of the present invention are carried out in one form by a tool for retaining a base of a tube support during installation of the base onto a surface. The base includes a body having an interior passage and a radially directed finger extending into the interior passage. The tool includes a rod having a groove extending along a length of the rod, the groove curving about a circumference of the rod at a distal end of the rod. The rod is configured to reside in the interior passage with the finger seated in the groove, and means extends from the distal end of the rod for selective release of the base from the rod.

The above and other advantages of the present invention are carried out in another form by a method for facilitating installation of a tube support onto a surface utilizing a base dispensing tool. The tool includes a rod, a plurality of bases loaded on the rod, and means extending from a distal end of the rod for selective release of the bases from the rod. The method calls for enabling, on the rod, a foot of a first one of the bases located at the distal end of the rod to face in a first direction that differs from a second direction of the foot of each of remaining ones of the plurality of bases. The distal end of the rod is positioned proximate a welding tip of a welding machine, and the foot of the first base is moved in contact with a weld tip of the welding machine. The method further calls for welding the foot to the surface and releasing the first base from the rod, a tube holder of the tube support being attachable to the first base.

### BRIEF-DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a perspective view of a pan channel letter;

FIG. 2 shows a front view of a tube support for the pan channel letter of FIG. 1;

FIG. 3 shows a side perspective-view of a base of the tube support of FIG. 2 in accordance with a preferred embodiment of the present invention;

FIG. 4 shows a top view of the base of FIG. 3;

FIG. 5 shows a front view of a base dispensing tool in accordance with a preferred embodiment of the present invention;

FIGS. 6a-c show various views of a rod of the base dispensing tool;

FIG. 7 shows a side view of the-base dispensing tool with a plurality of bases loaded thereon;

FIG. 8 shows a top cross section of the base dispensing tool and one of the bases of FIG. 3;

FIG. 9 shows a perspective view of the base dispensing tool utilized in connection with a welding machine; and

FIG. 10 shows a front view of a rocker arm of the welding machine with a retaining clamp-coupling the base dispensing tool to the rocker arm.

### DETAILED DESCRIPTION OF THE PREFERRED EMBODIMENTS

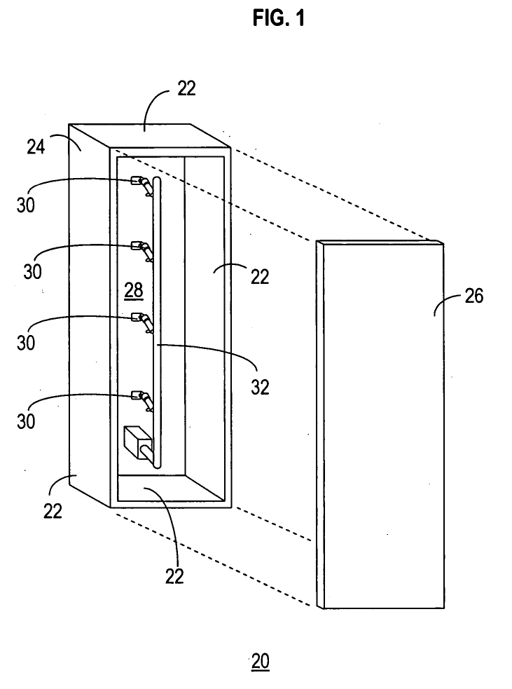

FIG. 1 shows a perspective view of a pan channel letter 20. Pan channel letter 20 includes side walls 22, a back wall 24, and a face 26 making letter 20 a solid integral unit. Face 26 is removed from letter 20 to reveal an inner surface 28 of back wall 24. Tube supports 30 are attached to inner surface 28 and support gas filled tube 32. In addition, tube supports 30 insulate gas filled tube 32 from inner surface 28.

Pan channel letter 20 is in the form of a vertically oriented bar, such as a lower case “l”, the numeral “1”, or an upper case “I” for simplicity of illustration. However, pan channel letter 20 can take on a great number of shapes including letters, numerals, symbols, pictures, and the like. The particular shape of pan channel letter 20 is not a limitation of the present invention.

Back wall 24 is typically manufactured from aluminum or some other sheet metal, and tube supports 30 are recessed in pan channel letter 20 to attach to the metal inner surface 28 of back wall 24. Consequently, manual fixation of tube supports 30 to back wall 24 can be difficult, tedious, and time consuming in the confined quarters of pan channel letter 20. The present invention facilitates installation of tube supports 30 into pan channel letter 20.

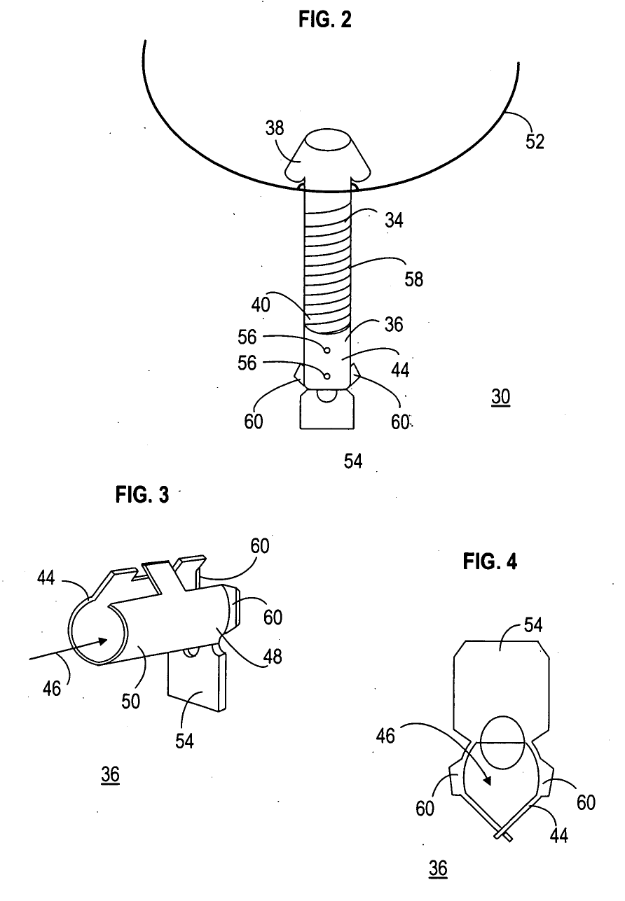

FIG. 2 shows a front view of one of tube supports 30 for pan channel letter 20 (FIG. 1). Tube support 30 includes a glass tube holder 34 supported by a base 36. Glass tube holder 34 includes a forked upper end 38 and a lower end 40 seated in base 36. Base 36 is fixed by welding, punching, or otherwise attaching base 36 to inner surface 28 (FIG. 1) of pan channel letter 20. A copper, or other similar, wire 42 is wrapped around glass tube holder 34. In use, gas filled tube 32 is supported, or cradled, by forked upper end 38 of glass tube holder 34. Wire 42 is wrapped around gas filled tube 32 and the projections of forked upper end 38 of glass tube holder 34 so as to hold tube 32 in position.

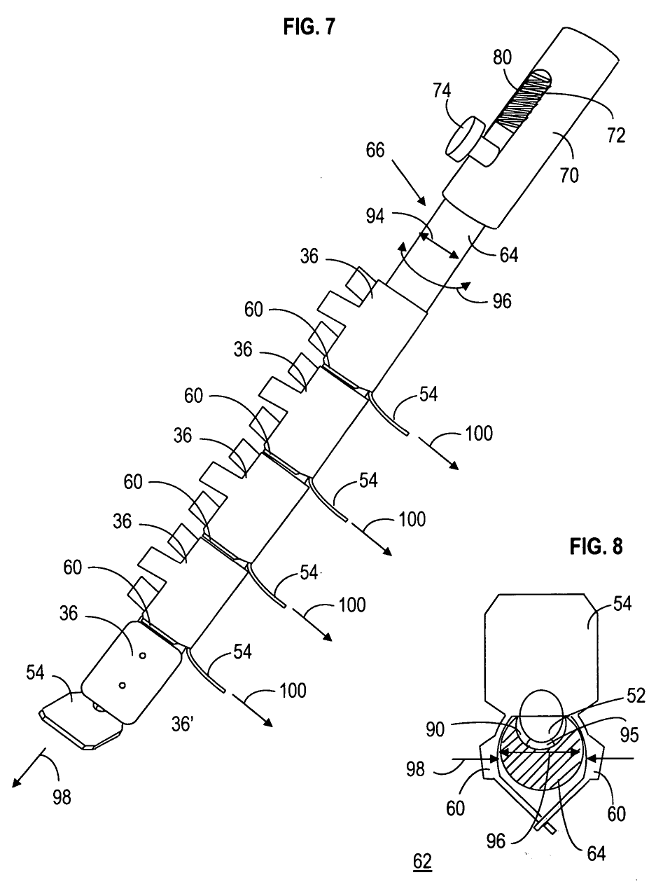

Referring to FIGS. 3-4 in connection with FIG. 2, FIG. 3 shows a side perspective view of base 36 of tube support 30 in accordance with a preferred embodiment of the present invention, and FIG. 4 shows a top view of base 36. Base 36 includes a body 44 having an interior passage 46 directed from a first end 48 to a second end 50 of body 44. In accordance with the present invention, a radially directed finger 52 is positioned proximate first end 48 of body 44 and extends into interior passage 46. Finger 52 will be discussed in further detail in connection with FIGS. 7 and 8.

A foot 54 is also positioned proximate first end 48 and extends outwardly from body 44. In an exemplary embodiment, base 36 is formed from stamped sheet metal, such as aluminum, and foot 54 is in the form of a generally solid flat section. During manufacturing of pan channel letter 20 (FIG. 1) the solid flat section forming foot 54 is welded to back wall 24 (FIG. 1) of letter 20. The solid flat section provides a relatively large surface area for fixation of base 36 to back wall 24 so as to achieve secure attachment of base 36.

Base 36 further includes at least one protrusion 56 extending into exterior passage 46 and positioned remote from first end 48. Protrusion 56 is readily formed by punching into the outer surface of body 44, but without actually punching through body 44. Thus, protrusion 56 is externally visible as indentations into body 36. Protrusion 56 is adapted to engage with a threaded, or ridged, portion 58 of glass tube holder 34. In particular, after base 36 has been fixed to inner surface 28 (FIG. 1), glass tube holder 34 is slid into interior passage 46. Ridged portion 58 of tube holder 34 engages with protrusion 56 to secure tube holder 34 into base 36.

Wings 60 are positioned proximate first end 48 and extend outwardly from body 44. The function of wings 60 will be discussed in further detail in connection with FIG. 7. In this exemplary illustration, wings 60 are positioned proximate first end 48. However, it should be understood that wings 60 may alternatively be positioned proximate second end 50. Base 36 is adapted to reside on a dispensing tool that can be utilized to facilitate installation of base 36 onto back wall 24 (FIG. 1) of pan channel letter 20 (FIG. 1). The features of base 36 including finger 52 and wings 60 function cooperatively to enable base 36 to be retained on and slide along the dispensing tool (discussed below).

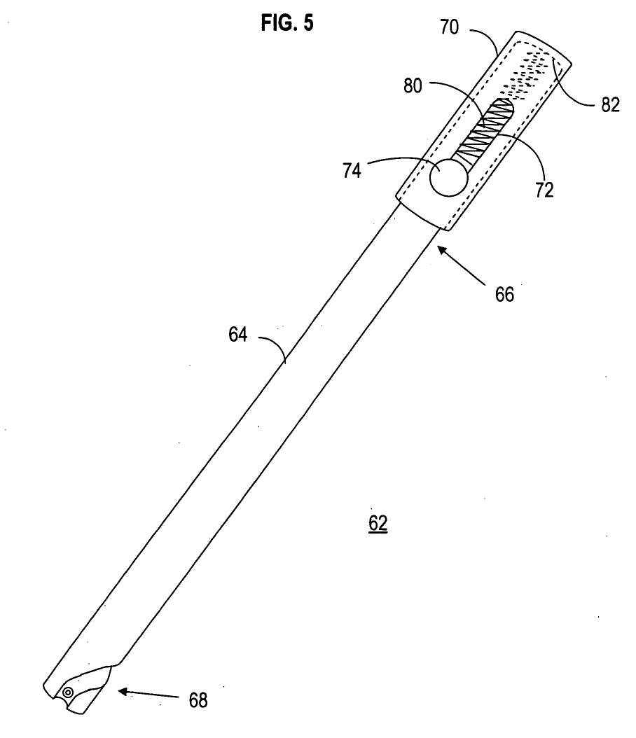

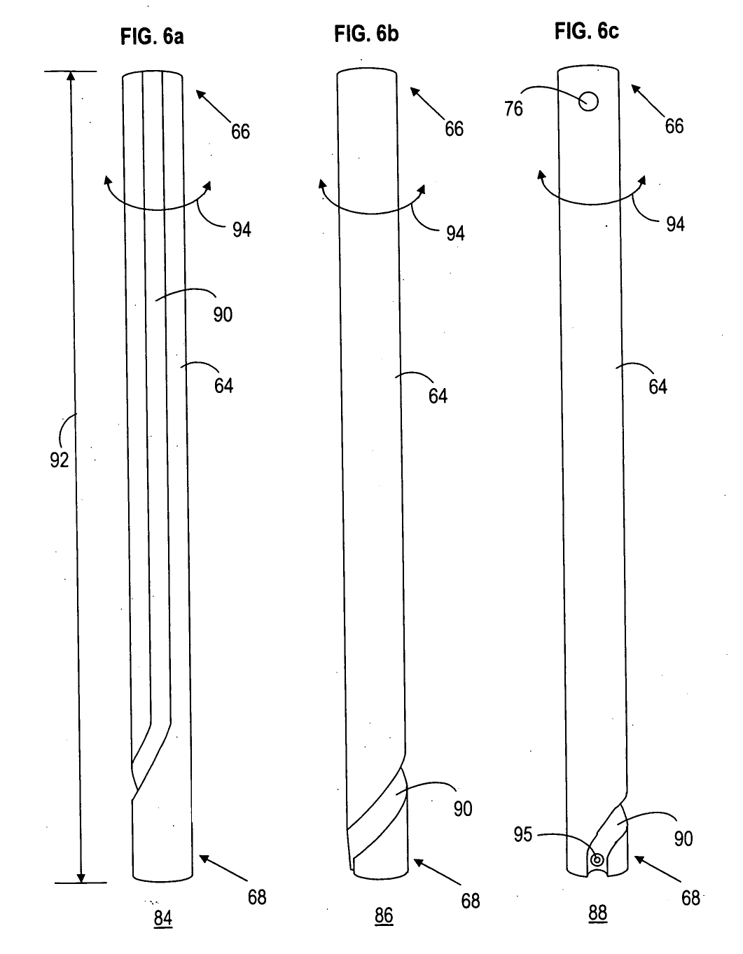

FIG. 5 shows a front view of a base dispensing tool 62 in accordance with a preferred embodiment of the present invention. Base dispensing tool 62 includes a rod 64 having a proximal end 66 and a distal end 68. A cap 70 is slidably coupled to proximal end 66 of rod 64. More specifically, cap 70 includes a longitudinally extending slot 72, and tool 62 further includes a fastener 74 extending through slot 72 and fastening into, for example, a threaded receiving hole 76 (see FIG. 6c) of rod 64. As cap 70 slides longitudinally, indicated by a bi-directional arrow 78, the cooperative nature of slot 72 and fastener 74 allows cap 70 to slide along rod 64 for a distance defined by a length of slot 72.

A spring 80 is housed inside of cap 70. Spring 80 is desirably fixed to an inner surface 82 of cap 70, but is not fixed to rod 64. Consequently, when fastener 74 is released from rod 64, rod 64 can be removed from cap 70 and replaced without the risk or inconvenience of losing spring 80.

FIGS. 6a-c show various views of rod 64 of base dispensing tool 62 (FIG. 5). For example, FIG. 6a shows a first surface 84 of the cylindrical rod 64. FIG. 6b shows a second surface 86 of rod 64, i.e., rod 64 rotated approximately ninety degrees relative to the view of rod 64 shown in FIG. 6a. Similarly, FIG. 6c shows a third surface 88 of rod 64, i.e., rod 64 rotated approximately ninety degrees relative to the view of rod-64 shown in FIG. 6b, and consequently approximately one hundred eighty degrees relative to the view of rod 64 shown in FIG. 6a.

Rod 64 has a groove 90 extending along a length 92 of rod 64. Groove 90 curves about a circumference 94 of rod 64 at distal end 68. In use, a plurality of bases, such as base 36 (FIG. 3), are loaded onto rod 64 with each finger 52 (FIG. 4) of each base 36 being seated in groove 90. Since a plurality of bases may be loaded onto rod 64, singular base 36 will be referred to as bases 36 hereinafter to express this multiplicity. The curvature of groove 90 causes bases 36 to pivot about circumference 94 due to the seating of finger 52 in groove 90.

Rod 64 further includes means extending from distal end 68 of rod 64 that enables selective release of bases 36 from rod 64. This releasing means is in the form of a projection 95 seated in groove 90. Projection 95 abuts finger 52 of the endmost one of bases 36 when bases 36 are loaded onto rod 64 to retain bases on rod 64. Rod 64 may be manufactured from a variety of materials, such as, metal, rigid molded plastics, and the like. In addition, projection 95 may be a spring-loaded ball installed in rod 64, or a simple molded or installed stationary pin, bump, or the like.

Referring to FIGS. 7-8, FIG. 7 shows a side view of base dispensing tool 62 with a plurality of bases 36 loaded thereon, and FIG. 8 shows a top cross section view of base dispensing tool 62 and one of the bases 36. As mentioned above, rod 64 can be separated from cap 70 with spring 80 being retained inside of cap 70. In addition, rod 64 of dispensing tool 62 exhibits an outer diameter 96 that is less than a diameter 98 of interior passage 46 so that bases 36 can readily slide along rod 64. Thus, bases 36 can be slid onto rod 64 from proximal end 66 to load and reload base dispensing tool 64. When held generally upright, bases 36 are then able to slide by gravity feed toward distal end 68 of rod 64. Wings 60 extending from each of bases 36 advantageously serve to prevent bases for sliding overtop one another as bases move along rod 64. Only five of bases 36 are loaded onto rod 64, for simplicity and clarity of illustration. However, rod 64 of tool 62 is elongated to enable a significantly larger number of bases 36 to reside in axial alignment on rod 64.

As exemplified in FIGS. 7-8, each finger 52 of each of bases 36 resides in groove 90. Due to the curvature of groove 90 and the location of finger 52 on each of bases 36, as bases 36 slide toward distal end 68 of rod 64, they pivot about circumference 94. Accordingly, an endmost one of bases 36, i.e. a base 36′, located at distal end 68 pivots so that its corresponding foot 54 faces in a first direction 98 that differs from a second direction 100 of foot 54 of each of the remaining bases 36.

This circumferential separation of foot 54 of endmost base 36′ relative to remaining bases 36 enables ready access to foot 54 of base 36′ for fixation of endmost base 36′ to a surface, such as inner surface 28 (FIG. 1) of pan channel letter 20 (FIG. 1). Projection 95 underlies finger 52 when endmost base 36′ is retained on rod 64. That is, projection 95 holds endmost base 36′ onto rod 64. When foot 54 of endmost base 36′ is fixed to inner surface 28, base dispensing tool 62 can be moved upwardly away from inner surface 28. The fixation of foot 54 to inner surface 28 causes endmost base 36′ to slide over projection 95 and remain in place on inner surface 28. In response, the remaining ones of bases 36 on dispensing tool 62 slide toward distal end 68, pivoting about circumference 94 at distal end 68.

Referring to FIGS. 9-10, FIG. 9 shows a perspective view of base dispensing tool 62 utilized in connection with a welding machine 102, and FIG. 10 shows a front view of a rocker arm 104 of welding machine 102 with a retaining clamp 106 coupling base dispensing tool 62 to rocker arm 104. Base dispensing tool 62 may be utilized in a variety of ways. For example, a welder can manually hold tool 62 at proximal end 66 (FIG. 7) and in a desired position with foot 54 of endmost base 36′ against inner surface 28 (FIG. 1) of pan channel letter 20 (FIG. 1). Alternatively, and as illustrated in FIGS. 9-10, base dispensing tool 62 may be fixed to welding machine 102 via retaining clamp 106 with distal end 68 of tool 62 positioned proximate the welding tip of welding machine 102 to further automate and simplify the manufacturing process.

In this exemplary embodiment, welding machine 102 is a spot welder. As known to those skilled in the art, spot welding is accomplished by overlapping pieces of metal, in this case, foot 54 of endmost base 36′ with inner surface 28 of pan channel letter 20, and applying great pressure and electrical current at small points, or dots, on foot 54 and inner surface 28. Welding machine 102 may be a resistance spot welder having a welding tip in the form of a first electrode 108 located on rocker arm 104 and a second electrode 110 located on a second arm 112.

In operation, foot 54 is placed into position on inner surface 28 of pan channel letter 20 between first and second electrodes 108 and 110, respectively. Rocker arm 104 is then rocked or moved downward, as represented by a bi-directional arrow 114 so that first and second electrodes 108 and 110 are moved into electrical contact through foot 54 and inner surface 28 to weld the two pieces together. Retaining clamp 106 fastens cap 70 of base dispensing tool 62 to rocker arm 104. Thus, tool 62 moves in concert with rocker arm 104. Moreover, as downward movement of rocker arm 104 occurs, spring 80 inside cap 70 allows base dispensing tool 62 to accommodate this movement. Following the spot-welding procedure, as rocker arm 104 moves upward, endmost base 36′ remains fixed to inner surface 28 of pan channel letter 20, and remaining bases 36 slide downward on rod 64. That is, finger 52 (FIG. 8) of endmost base 36′ slides over projection 95 (FIG. 8) on tool 62 to release from rod 64. The welder can then simply move pan channel letter 20 to the desired position and repeat the procedure for attachment of the next one of bases 36.

Retaining clamp 106 is illustrated herein as a fixed unit for simplicity of illustration. However, retaining clamp 106 may take on a variety of forms and include additional features that allow base dispensing tool 62 to have a more universal fit for various welding machines. For example, retaining clamp 106 may include a tilt mechanism and/or mechanisms that allow base dispensing tool 62 to move upwardly and downwardly relative to rocker arm 104 or to move toward or away from rocker arm 104. These adjustments would allow for optimal placement of endmost base 36′ relative to the welding tip, ex., first and second electrodes 108 and 110.

The attachment between cap 70 of base dispensing tool 62 and retaining clamp 106 further allows ready reloading of rod 64 when it is emptied of bases 36. That is, rod 64 can be removed from cap 70 by removing fastener 74, with cap 70 remaining in place on retaining clamp 106. Rod 64 can then be reloaded with bases 36 and reattached to cap 70. Alternatively, rod 64 loaded with bases 36 may be marketed as a disposable unit separate from cap 70. As such, when rod 64 is emptied of bases 36, rod 64 can be removed from cap 70, and can subsequently be replaced with a second rod 64 loaded with a second plurality of bases 36.

Following spot-welding of the desired number of bases 36 into pan channel letter 20, glass tube holder 34 (FIG. 2) is simply installed into the attached bases 36. Fabrication of pan channel letter 20 can then continue with installation of gas filled tube 32 (FIG. 1) and associated components, and sealing pan channel letter 20 with face 26 (FIG. 1) per conventional procedures.

In summary, the present invention teaches of a base dispensing tool having a gravity feed feature that provide bases of tube supports to a surface for attachment to the surface. The design of the base dispensing tool yields a system that can be cost effectively manufactured. Moreover, the feed mechanism of dispensing tool and installation methodology for the bases significantly speeds up sign fabrication processes, thus reducing production costs for neon signage. In addition, the utilization of the dispensing tool, specialized bases, and associated installation methodology leads to more accurate placement and secure attachment of the tube support bases, thus increasing production quality of neon signage.

Although the preferred embodiments of the invention have been illustrated and described in detail, it will be readily apparent to those skilled in the art that various modifications may be made therein without departing from the spirit of the invention or from the scope of the appended claims. For example, although the present invention is taught in connection with fixation of bases into a pan channel letter, the invention can be readily adapted for attachment of bases, or other components that include the interior passage and finger described here, to other signage surfaces, decorative surfaces, and the like.

What is claimed is:

1. A tool for retaining a base of a tube support during installation of said base onto a surface, said base including a body having an interior passage and a radially directed finger extending into said interior passage, and said tool comprising:
a rod having a groove extending along a length of said rod, said groove curving about a circumference of said rod at a distal end of said rod, said rod being configured to reside in said interior passage with said finger seated in said groove; and
means extending from said distal end of said rod for selective release of said base from said rod.

2. A tool as claimed in claim 1 wherein said selective release means comprises a projection seated in said groove, said projection abutting said finger to selectively retain said base onto said rod.

3. A tool as claimed in claim 1 further comprising a cap slidably coupled with a proximal end of said rod.

4. A tool as claimed in claim 3 further comprising a spring housed inside of said cap, said spring imparting a spring force between said rod and said cap.

5. A tool as claimed in claim 4 wherein said spring is fixed to said inner surface of said cap.

6. A tool as claimed in claim 3 wherein:
said cap includes a longitudinally extending slot; and
said tool further comprises a fastener extending through said slot and attaching to said rod for coupling said cap to said rod.

7. A tool as claimed in claim 1 wherein said tool is utilized with a welding machine, and said tool further comprises a retainer in communication with said rod and configured for attachment to said welding machine with said distal end of said rod positioned proximate a welding tip of said welding machine.

8. A tool as claimed in claim 1 wherein said rod exhibits an outer diameter that is less than a diameter of said interior passage for slidable accommodation of said base on said rod.

9. A tool as claimed in claim 1 wherein said rod is elongated to enable a plurality of bases to reside in axial alignment on said rod, said base being one of said plurality of bases.

10. A tool as claimed in claim 9 wherein each of said plurality of bases further includes a foot integrally formed on said body, and said finger seated in said groove of said rod causes said foot of an endmost one of said bases located at said distal end of said rod to face in a first direction that differs from a second direction of said foot from each of remaining ones of said plurality of bases.

11. A dispensing tool for facilitating installation of tube supports onto a surface comprising:
a rod having a groove extending along a length of said rod, said groove curving about a circumference of said rod at a distal end of said rod;
a plurality of bases for said tube supports, each of said bases including a body and a foot formed integrally thereon, said body having an interior passage and a radially directed finger extending into said interior passage, and said rod being directed through said interior passage of said each base with said finger being seated in said groove such that said foot of an endmost one of said bases located at said distal end of said rod faces in a first direction that differs from a second direction of said foot from each of remaining ones of said plurality of bases; and
means extending from said distal end of said rod for selective release of said endmost one of said bases from said rod.

12. A dispensing tool as claimed in claim 11 further comprising:
a cap slidably coupled to a proximal end of said rod; and
a spring housed inside of said cap, said spring imparting a spring force between said rod and said cap.

13. A dispensing tool as claimed in claim 12 wherein said system is utilized with a welding machine, and said dispensing tool system further comprises a retaining clamp coupled to said cap and configured for attachment to said welding machine with said distal end of said rod positioned proximate a welding tip of said welding machine.

14. A method of facilitating installation of a tube support onto a surface utilizing a base dispensing tool, said tool including a rod, a plurality of bases loaded on said rod, and means extending from a distal end of said rod for selective release of said bases from said rod, said method comprising:
enabling, on said rod, a foot of a first one of said bases located at said distal end of said rod to face in a first direction that differs from a second direction of said foot of each of remaining ones of said plurality of bases;
positioning said distal end of said rod proximate a welding tip of a welding machine;
moving said foot of said first base in contact with a weld tip of said welding machine;
welding said foot to said surface; and
releasing said first base from said rod, a tube holder of said tube support being attachable to said first base.

15. A method as claimed in claim 14 further comprising:
allowing said remaining ones of said bases to slide toward said distal end along said rod; and
repeating said enabling, positioning, moving, welding, and releasing operations for a second one of said remaining bases.

16. A method as claimed in claim 14 further comprising attaching, prior to said moving step, said base dispensing tool to an arm of said welding machine.

17. A method as claimed in claim 16 wherein said tool further includes a cap slidably coupled to a proximal end of said rod, and:
said attaching operation couples said cap to said arm of said welding machine; and
when all of said bases are released from said rod, said method further comprises:
removing said rod from said cap; and
installing a second rod into said cap, said second rod having a second plurality of bases loaded thereon and means extending from said distal end of said second rod for selective release of said second plurality of bases from said second rod.

18. A base for a tube support, said tube support useable for holding a tube, said base comprising:
a body having an interior passage directed from a first end to a second end of said body;
a radially directed finger extending into said interior passage, said radially directed finger being positioned proximate said first end of said body; and
a foot extending outwardly from said body, said foot being positioned proximate said first end of said body.

19. A base as claimed in claim 18 wherein said tube support includes a tube holder, and said base further comprises a protrusion extending into said interior passage remote from said first end and adapted to engage with said tube holder.

20. A base as claimed in claim 18 wherein said base is installable onto a surface utilizing a dispensing tool, said tool including a rod supporting a plurality of bases, said base being one of said plurality of bases, and said base further comprises a wing extending outwardly from said body, said wing being positioned proximate one of said first and second ends of said body.

21. A base as claimed in claim 18 wherein said foot comprises a generally solid flat section.
